(19) United States
(12) Patent Application Publication
(10) Pub. No.: US 2012/0039735 A1
(43) Pub. Date: Feb. 16, 2012

(54) Variable capacity rotary compressor and air conditioning system having the same

(75) Inventor: Jeong Bae Lee, Hwaseong-si (KR)

(73) Assignee: SAMSUNG ELECTRONICS CO., LTD., Suwon-si (KR)

(21) Appl. No.: 13/067,199

(22) Filed: May 16, 2011

(30) Foreign Application Priority Data
Aug. 13, 2010 (KR) 10-2010-0078318

(51) Int. Cl. F03C 2/00

(52) U.S. Cl. 418/63

(57) ABSTRACT

A rotary compressor, the capacity of which is variable with a simplified configuration, and an air conditioning system having the rotary compressor. The rotary compressor is used in an air conditioning system including a condenser, a compressor, an evaporator, and an expansion valve, and includes a housing, a compressing chamber defined in the housing, and a vane to be moved forward or rearward in a radial direction of the compressing chamber. The vane is moved forward or rearward depending on an opening rate of the expansion valve.

### CROSS-REFERENCE TO RELATED APPLICATIONS

This application claims the priority benefit of Korean Patent Application No. 10-2010-0078318, filed on Aug. 13, 2010 in the Korean Intellectual Property Office, the disclosure of which is incorporated herein by reference.

### BACKGROUND

1. Field

Embodiments relate to a variable capacity rotary compressor having a variable refrigerant compression capacity and an air conditioning system having the same.

2. Description of the Related Art

A rotary compressor is used in an air conditioning system to compress refrigerant. Recently, a variable capacity rotary compressor, the capacity of which is variable to efficiently deal with various refrigeration loads, has been widely used.

A conventional variable capacity rotary compressor includes two cylinders or compressing chambers, which are mechanically controlled such that one of the cylinders always performs compression of refrigerant and the other cylinder selectively performs compression of refrigerant only as necessary.

In this case, selectively performing compression of refrigerant only as necessary may require control of the pressure of refrigerant introduced into the cylinder. To this end, a variety of valves and flow-path mechanisms have been used, leading to a complicated configuration.

Using these various additional valves and flow-path mechanisms to control the pressure of refrigerant may deteriorate performance of the compressor and also, may require changes in connection configurations between the compressor and the valves and flow-path mechanisms. Therefore, there is a need for a configuration to control the pressure of refrigerant in a more simplified manner.

### SUMMARY

Therefore, it is one aspect to provide a rotary compressor, the capacity of which is variable with a simplified configuration, and an air conditioning system having the rotary compressor.

It is another aspect to provide a rotary compressor to enable efficient compression of refrigerant and an air conditioning system having the rotary compressor.

Additional aspects of the invention will be set forth in part in the description which follows and, in part, will be apparent from the description, or may be learned by practice of the invention.

In accordance with one aspect, a compressor, used in an air conditioning system including a condenser, a compressor, an evaporator and an expansion valve, includes a housing, a compressing chamber defined in the housing, and a vane to be moved forward or rearward in a radial direction of the compressing chamber, wherein the vane is moved forward or rearward depending on an opening rate of the expansion valve.

A pulling member may be placed between an inner circumferential surface of the housing and a rear end of the vane and serves to force the vane rearward.

The pulling member may be a magnet.

The pulling member may be an elastic member.

The compressor may further include a bypass valve placed in parallel to the expansion valve to bypass refrigerant to be introduced into the expansion valve.

The vane may be divided into at least two individually movable vanes.

The pulling member may be placed at the rear of one of the at least two divided vanes.

In accordance with another aspect, a compressor, used in an air conditioning system including a condenser, a compressor, an evaporator and an expansion valve, includes a housing, a first compressing chamber and a second compressing chamber defined in the housing, a first vane to be moved forward or rearward in a radial direction of the first compressing chamber, and a second vane to be moved forward or rearward in a radial direction of the second compressing chamber, wherein any one of the first vane and the second vane is moved forward or rearward depending on an opening rate of the expansion valve.

The first compressing chamber may be located above the second compressing chamber.

A pulling member may be placed at the rear of any one of the first vane and the second vane and may serve to force any one of the first vane and the second vane rearward.

The pulling member may be a magnet.

The pulling member may be an elastic member.

The compressor may further include a bypass valve placed in parallel to the expansion valve to bypass refrigerant to be introduced into the expansion valve.

Any one of the first vane and the second vane may be divided into at least two individually movable vanes.

In accordance with another aspect, a compressor, used in an air conditioning system including a condenser, a compressor, an evaporator and an expansion valve, includes a housing, a low-pressure pipe connected to the housing to enable introduction of relatively low-pressure refrigerant, a high-pressure pipe connected to the housing to enable discharge of relatively high-pressure refrigerant, a first compressing chamber and a second compressing chamber defined in the housing, and a first vane to be moved forward or rearward in a radial direction of the first compressing chamber and a second vane to be moved forward or rearward in a radial direction of the second compressing chamber, wherein any one of the first vane and the second vane is moved forward or rearward depending on a difference between the pressure of refrigerant introduced into the low-pressure pipe and the pressure of refrigerant discharged from the high-pressure pipe.

The difference between the pressure of refrigerant introduced into the low-pressure pipe and the pressure of refrigerant discharged from the high-pressure pipe may be adjusted by controlling an opening rate of the expansion valve.

The compressor may further include a bypass valve placed in parallel to the expansion valve to bypass refrigerant to be introduced into the expansion valve.

A pulling member may be placed at the rear of any one of the first vane and the second vane and may serve to force any one of the first vane and the second vane rearward.

Any one of the first vane and the second vane may be divided into at least two individually movable vanes.

In accordance with a further aspect, a compressor, used in an air conditioning system including a condenser, a compressor, an evaporator and an expansion valve, includes a housing, a low-pressure pipe connected to the housing to enable introduction of relatively low-pressure refrigerant, a high-pressure pipe connected to the housing to enable discharge of relatively high-pressure refrigerant, a first compressing chamber and a second compressing chamber defined in the housing, and a first vane to be moved forward or rearward in a radial direction of the first compressing chamber and a second vane to be moved forward or rearward in a radial direction of the second compressing chamber, wherein any one of the first vane and the second vane is moved forward or rearward as a difference between the pressure of refrigerant introduced into the low-pressure pipe and the pressure of refrigerant discharged from the high-pressure pipe is adjusted by controlling an opening rate of the expansion valve.

### BRIEF DESCRIPTION OF THE DRAWINGS

These and/or other aspects of the invention will become apparent and more readily appreciated from the following description of the embodiments, taken in conjunction with the accompanying drawings of which:

FIG. 1 is a longitudinal sectional view of a variable capacity rotary compressor according to an embodiment;

FIG. 2 is a plan sectional view illustrating a first compressing chamber provided in the variable capacity rotary compressor according to the embodiment;

FIG. 3 is a plan sectional view illustrating a second compressing chamber provided in the variable capacity rotary compressor according to the embodiment;

FIG. 4 is a diagram illustrating an air conditioning system using a variable capacity rotary compressor according to an embodiment of;

FIG. 5 is a diagram illustrating an air conditioning system with an additional bypass valve as compared to FIG. 4;

FIG. 6 is an enthalpy-pressure diagram of an air conditioning system according to an embodiment; and

FIG. 7 is a sectional view illustrating a dividable vane provided in the variable capacity rotary compressor according to an embodiment.

### DETAILED DESCRIPTION

Reference will now be made in detail to an exemplary embodiment, examples of which are illustrated in the accompanying drawings, wherein like reference numerals refer to like elements throughout.

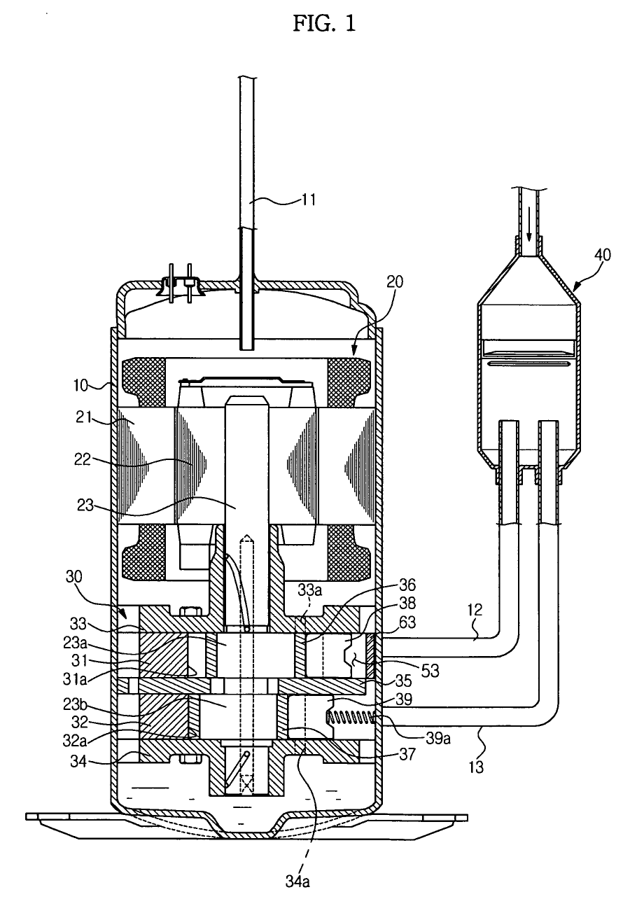

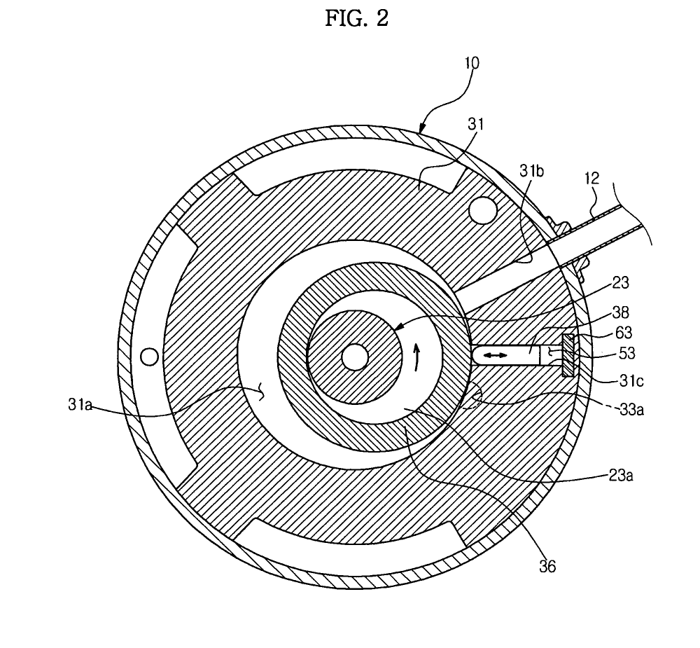

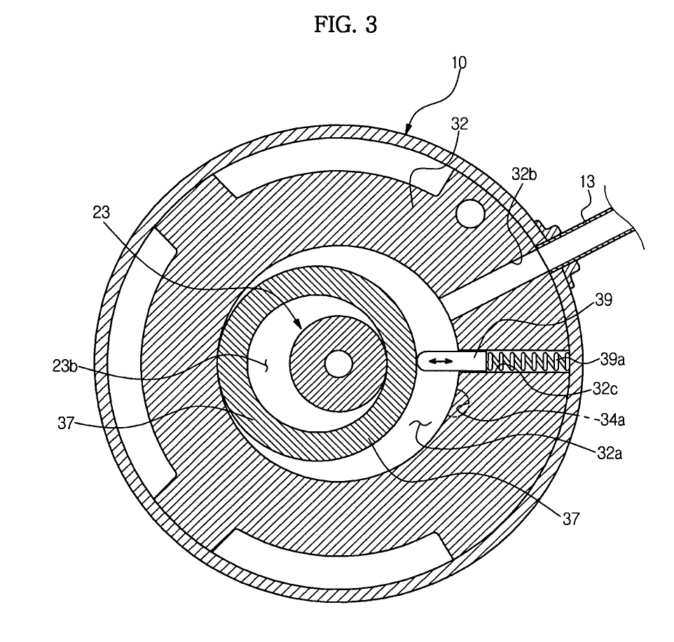

FIG. 1 is a longitudinal sectional view of a variable capacity rotary compressor according to an embodiment, FIG. 2 is a plan sectional view illustrating a first compressing chamber provided in the variable capacity rotary compressor according to the embodiment, and FIG. 3 is a plan sectional view illustrating a second compressing chamber provided in the variable capacity rotary compressor according to the embodiment.

As illustrated in FIG. 1, the variable capacity rotary compressor 100 according to the embodiment is used to compress refrigerant in an air conditioning system. The variable capacity rotary compressor 100 includes a housing 10 defining an external appearance of the compressor 100, a drive device 20 placed in the housing 10 to generate rotating power, and a compressing device 30 to compress refrigerant upon receiving power from the drive device 20. An accumulator 40 is installed around the housing 10, serves to vaporize liquid-phase refrigerant which has not evaporated in an evaporator (not shown) constituting an air conditioning system, and allows gas-phase refrigerant to be introduced into the compressing device 30.

The drive device 20 includes a cylindrical stator 21 fixed to an inner surface of the housing 10, a rotator 22 rotatably installed inside the stator 21, and a rotating shaft 23 having one end fixed to the rotator 22 and the other end installed to the compressing device 30 so as to transmit rotating power generated by the drive device 20 to the compressing device 30.

The compressing device 30, as illustrated in FIGS. 2 and 3, includes a first cylinder 31 and a second cylinder 32 respectively having a first compressing chamber 31a and a second compressing chamber 32a for compression of refrigerant, a first flange 33 and a second flange 34 configured to close an upper end of the first compressing chamber 31a and a lower end of the second compressing chamber 32a while rotatably supporting the rotating shaft 23, and an intermediate plate 35 interposed between the first cylinder 31 and the second cylinder 32 to divide the first compressing chamber 31a and the second compressing chamber 32a from each other.

The first compressing chamber 31a and the second compressing chamber 32a respectively receive a first roller 36 and a second roller 37, which compress refrigerant by being eccentrically rotated upon receiving rotating power from the rotating shaft 23. To allow the first roller 36 and the second roller 37 to be eccentrically rotated in the first compressing chamber 31a and the second compressing chamber 32a, respectively, the rotating shaft 23 includes a first eccentric portion 23a and a second eccentric portion 23b, which are eccentric to a rotation center of the rotating shaft 23. The first roller 36 is rotatably installed around the first eccentric portion 23a, and the second roller 37 is rotatably installed around the second eccentric portion 23b.

A discharge pipe 11 is connected to an upper end of the housing 10 to discharge compressed refrigerant from the housing 10. A first suction pipe 12 and a second suction pipe 13 are connected to lower peripheral positions of the housing 10 to suction refrigerant to be compressed in the first compressing chamber 31a and the second compressing chamber 32a.

The first cylinder 31 and the second cylinder 32 are respectively provided with a first suction port 31b and a second suction port 32b, which are connected to the first suction pipe 12 and the second suction pipe 13, respectively, such that refrigerant having passed through the first suction pipe 12 and the second suction pipe 13 is suctioned into the first compressing chamber 31a and the second compressing chamber 32a.

Since the refrigerant discharged through the discharge pipe 11 has a higher pressure than the refrigerant introduced through the first suction pipe 12 and the second suction pipe 13, the discharge pipe 11 serves as a high-pressure pipe and the first suction pipe 12 and the second suction pipe 13 serve as low-pressure pipes.

The first flange 33 and the second flange 34 are provided with a first discharge port 33a and a second discharge port 34a, respectively, to allow the refrigerant compressed in the first compressing chamber 31a and the second compressing chamber 32a to be discharged into the interior of the housing 10.

A first vane 38 is installed in the first compressing chamber 31a. The first vane 38 is movable forward or rearward in a radial direction of the first roller 36 and serves to divide the interior of the first compressing chamber 31a into a refrigerant compression region and a refrigerant suction region when a tip end of the first vane 38 is supported by the first roller 36.

A second vane 39 is installed in the second compressing chamber 32a and is elastically supported by an elastic member 39a. The second vane 39 is movable forward or rearward in a radial direction of the second roller 37 and serves to divide the interior of the second compressing chamber 32a into a refrigerant compression region and a refrigerant suction region when a tip end of the second vane 39 is supported by the second roller 37.

The first cylinder 31 and the second cylinder 32 are provided with a first guide groove 31c and a second guide groove 32c, respectively. The first vane 38 and the second vane 39 are movable forward or rearward in the first guide groove 31c and the second guide groove 32c, respectively.

In the variable capacity rotary compressor 100 having the above-described configuration, the capacity of the compressor may vary via forward or rearward movement of the first vane 38. This will be described hereinafter.

Hereinafter, a configuration and method for varying the capacity of the variable capacity rotary compressor 100 according to the embodiment through control of an expansion valve 300 will be described.

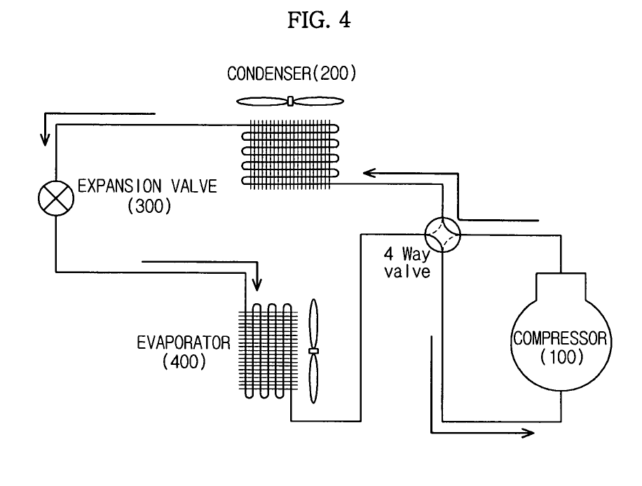

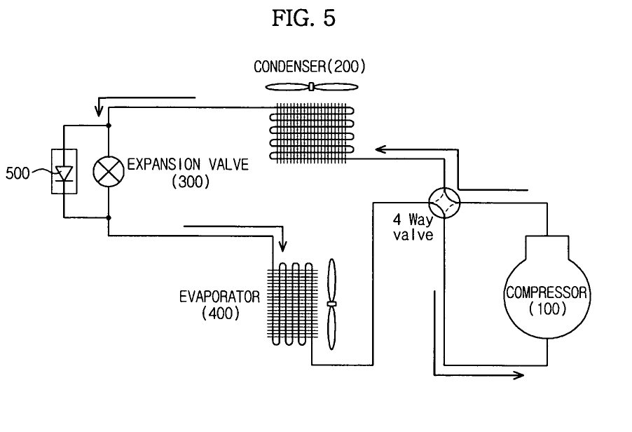

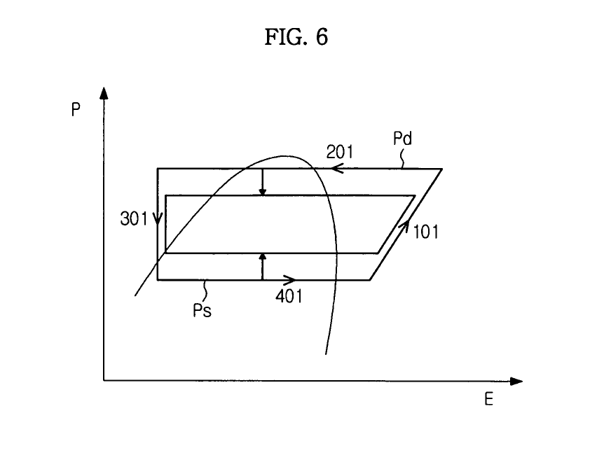

FIG. 4 is a diagram illustrating an air conditioning system using a variable capacity rotary compressor according to an embodiment, FIG. 5 is a diagram illustrating an air conditioning system with an additional bypass valve as compared to FIG. 4, and FIG. 6 is an enthalpy-pressure diagram of an air conditioning system according to an embodiment.

As illustrated in FIG. 4, the air conditioning system according to the embodiment includes the variable capacity rotary compressor 100, condenser 200, expansion valve 300, and evaporator 400.

The condenser 200 serves to condense and liquefy high-temperature and high-pressure gas-phase refrigerant discharged from the rotary compressor 100 into high-temperature and high-pressure liquid-phase refrigerant by transferring heat of the gas-phase refrigerant to peripheral air or cooling water.

The expansion valve 300 serves to expand the high-temperature and high-pressure liquid-phase refrigerant having passed through the condenser 200 into low-temperature and low-pressure liquid-phase refrigerant.

The evaporator 400 serves to change the low-temperature and low-pressure liquid-phase refrigerant having passed through the expansion valve 300 into low-temperature and low-pressure gas-phase refrigerant.

The rotary compressor 100 serves as a pump to circulate refrigerant in the air conditioning system. Specifically, the rotary compressor 100 serves to increase the pressure of refrigerant to a saturation pressure corresponding to a condensation temperature sufficient to suction low-temperature and low-pressure gas-phase refrigerant evaporated in the evaporator, thereby allowing the low-temperature and low-pressure gas-phase refrigerant to be liquefied in the condenser 200.

As illustrated in FIGS. 1 to 4, the variable capacity rotary compressor 100 may vary the compression capacity thereof via forward or rearward movement of the first vane 38. The forward or rearward movement of the first vane 38 is determined based on a difference between the pressure of refrigerant at the rear of the first vane 38 and the pressure of refrigerant introduced into the first compressing chamber 31a through the first suction pipe 12. In this case, a space 53 at the rear of the first vane 38 communicates with the discharge pipe 11 and thus, has the same pressure as that of the compressed refrigerant discharged through the discharge pipe 11.

If the pressure of refrigerant at the rear of the first vane 38 is greater than the pressure of refrigerant at the front of the first vane 38, i.e. inside the first compressing chamber 31a, the first vane 38 is moved forward into the first compressing chamber 31a such that the tip of the first vane 38 is supported by the first roller 36. Thereby, the interior of the first compressing chamber 31a is divided into a refrigerant suction region and a refrigerant compression region by the first vane 38. In this way, refrigerant is compressed within the first compressing chamber 31a.

If the pressure of refrigerant inside the first compressing chamber 31a is similar to or greater than the pressure of refrigerant at the rear of the first vane 38, the first vane 38 is moved rearward from the first compressing chamber 31a such that the tip end of the first vane 38 is spaced apart from the first roller 36. Thus, the first vane 38 does not divide the interior of the first compressing chamber 31a, causing the first roller 36 located in the first compressing chamber 31a to perform idle rotation. In this way, refrigerant is not compressed within the first compressing chamber 31a.

The second vane 39, installed in the second compressing chamber 32a, is elastically supported at a rear end thereof by the elastic member 39a. Thus, in a state in which the tip end of the second vane 39 comes into contact with the second roller 37, the second vane 39 is moved forward or rearward in a radial direction of the second compressing chamber 32a depending on rotation of the second roller 37, thereby dividing the second compressing chamber 32a into a refrigerant compression region and a refrigerant suction region. In this way, refrigerant is always compressed in the second compressing chamber 32a.

As described above, the refrigerant introduced into the second compressing chamber 32a is always compressed and discharged, whereas the refrigerant introduced into the first compressing chamber 31a is selectively compressed depending on forward or rearward movement of the first vane 38. Accordingly, the capacity of the variable capacity rotary compressor 100 varies according to whether the refrigerant introduced into the first compressing chamber 31a is compressed or not.

When the first vane 38 is moved forward or rearward based on a difference between the pressure of refrigerant at the rear of the first vane 38 and the pressure of refrigerant at the front of the first vane 38, i.e. between the pressure of refrigerant discharged through the discharge pipe 11 and the pressure of refrigerant inside the first compressing chamber 31a, the pressure difference between the front and the rear of the first vane 38 may be controlled by the expansion valve 300.

More specifically, as illustrated in the enthalpy-pressure diagram of FIG. 6, the refrigerant compressed in the rotary compressor 100 is increased in pressure to the highest pressure point Pd in the cycle (101) and then is liquefied by dissipating heat to the outside while passing through the condenser 200 (201). The liquefied refrigerant is lowered in pressure while passing through the expansion valve 300 (301) to the lowest pressure Ps and is changed into gas-phase refrigerant while passing through the evaporator 400 (401), thereby being returned to the rotary compressor 100.

The expansion valve 300 operates based on the principle that pressure decreases when the area of the path narrows. In the air conditioning system, the pressure of refrigerant is lowered by providing the expansion valve with a smaller cross section than that of a refrigerant flow path.

In addition, the expansion valve 300 is configured to be opened or closed such that the cross section of a refrigerant passage region thereof may be controlled based on an opening rate of the expansion valve 300.

When the opening rate of the expansion valve 300 is sufficiently reduced, the pressure of refrigerant is greatly lowered, causing a great difference between the highest pressure Pd and the lowest pressure Ps. On the contrary, when the opening rate of the expansion valve 300 is sufficiently increased, the pressure of refrigerant is only slightly lowered as designated by the arrows illustrated in the enthalpy-pressure diagram of FIG. 6, causing a reduced difference between the highest pressure Pd and the lowest pressure Ps.

In this case, the highest pressure Pd is substantially equal to the pressure of refrigerant discharged from the rotary compressor 100, and the lowest pressure Ps is substantially equal to the pressure of refrigerant introduced into the rotary compressor 100.

As described above, since the pressure of refrigerant discharged from the rotary compressor 100 is equal to the pressure of refrigerant discharged through the discharge pipe 11 and the pressure of refrigerant discharged through the discharge pipe 11 is equal to the pressure acting on the rear of the first vane 38, the pressure at the rear of the first vane 38 is equal to the highest pressure Pd.

In addition, since the pressure of refrigerant Ps introduced into the rotary compressor 100 is equal to the pressure of refrigerant introduced into the first compressing chamber 31a, the pressure at the front of the first vane 38 is equal to the lowest pressure Ps.

Accordingly, a pressure difference between the front and the rear of the first vane 38 may be controlled by controlling the opening rate of the expansion valve 300.

When the opening rate of the expansion valve 300 is reduced, a difference between the highest pressure Pd and the lowest pressure Ps, i.e. a difference between the pressure at the rear of the first vane 38 and the pressure at the front of the first vane 38 is increased. In this case, the first vane 38 is moved forward into the first compressing chamber 31a such that the tip end of the first vane 38 is supported by the first roller 36. Thereby, as the interior of the first compressing chamber 31a is divided into a refrigerant suction region and a refrigerant compression region by the first vane 38, refrigerant is compressed in the first compressing chamber 31a.

When the opening rate of the expansion valve 300 is increased, there is only a slight difference between the highest pressure Pd and the lowest pressure Ps, i.e. between the pressure of refrigerant at the rear of the first vane 38 and the pressure of refrigerant at the front of the first vane 38.

As illustrated in FIGS. 1 and 2, a pulling member 63 is placed between an inner circumferential surface of the housing 10 and a rear end of the first vane 38, and serves to force the first vane 38 rearward. Therefore, if force applied to the first vane 38 by the pulling member 63 is greater than a difference between the pressure at the front of the first vane 38 and the pressure at the rear of the first vane 38, the first vane 38 is moved rearward away from the first compressing chamber 31a such that the tip end of the first vane 38 is spaced apart from the first roller 36. Thereby, as the first compressing chamber 31a does not divide the interior of the first compressing chamber 31a, the first roller 36 performs idle rotation and refrigerant is not compressed in the first compressing chamber 31a.

The pulling member 63 used to force the first vane 38 rearward may be a magnet, a spring or the like.

The above-described effect, as illustrated in FIG. 5, may be obtained by adding a bypass valve 500 in parallel to the expansion valve 300.

Specifically, the bypass valve 500 is connected in parallel to the expansion valve 300 so as to bypass a part of the refrigerant to be introduced into the expansion valve 300. This has the effect of reducing a difference between the pressure at the front of the first vane 38 and the pressure at the rear of the first vane 38, and causing the first vane 38 to be spaced apart from the first roller 36. In this way, the capacity of the rotary compressor 100 may vary.

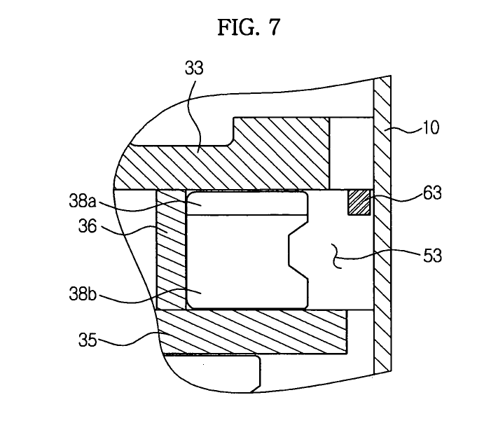

FIG. 7 is a sectional view illustrating a dividable vane provided in the variable capacity rotary compressor according to an embodiment.

As illustrated in FIG. 7, the first vane 38 may be divided into an upper first vane 38a and a lower first vane 38b, and the pulling member 63 may be located only at the rear of the upper first vane 38a.

In this case, the upper first vane 38a may be separated from the lower first vane 38b so as to be moved forward or rearward independently of the lower first vane 38b.

If the opening rate of the expansion valve 300 is increased to reduce a difference between the highest pressure Pd and the lowest pressure Ps, i.e. a difference between the pressure at the front of the first vane 38 and the pressure at the rear of the first vane 38, only the upper first vane 38a is moved rearward by the pulling member 63 provided at the rear of the upper first vane 38a.

Even if the upper first vane 38a is moved rearward, the interior of the first compressing chamber 31a is not divided, causing the first roller 36 located in the first compressing chamber 31a to perform idle rotation and preventing compression of refrigerant from taking place in the first compressing chamber 31a.

As described above, as the first vane 38 is divided into the upper first vane 38a and the lower first vane 38b such that only the upper first vane 38a is moved forward or rearward, the compression capacity of the rotary compressor 100 may be more precisely controlled.

Meanwhile, the first compressing chamber 31a and the second compressing chamber 32a may have the same or different volumes.

Assuming that the first compressing chamber 31a and the second compressing chamber 32a have the same volume, the variable capacity rotary compressor according to the embodiment operates at up to the maximum capacity if refrigerant is compressed in the first compressing chamber 31a, and operates at up to approximately 50% of the maximum capacity if the first compressing chamber 31a performs idle rotation.

Assuming that the first compressing chamber 31a and the second compressing chamber 32a do not have the same volume, for example, assuming that the volume of the first compressing chamber 31a is double that of the second compressing chamber 32a, the variable capacity rotary compressor according to the embodiment operates at up to the maximum capacity if refrigerant is compressed in the first compressing chamber 31a, and operates at up to approximately 33% of the maximum capacity if the first compressing chamber 31a performs idle rotation.

As is apparent from the above description, a variable capacity rotary compressor according to the embodiments may achieve improved compression efficiency, in particular, in a low-load region.

Further, material costs required to realize a variable compression capacity may be reduced, resulting in improved productivity of the variable capacity rotary compressor.

Although the embodiment has been shown and described, it would be appreciated by those skilled in the art that changes may be made in these embodiments without departing from the principles and spirit of the invention, the scope of which is defined in the claims and their equivalents.

What is claimed is:

1. A compressor used in an air conditioning system including a condenser, a compressor, an evaporator, and an expansion valve, the compressor comprising:
a housing;
a compressing chamber defined in the housing; and
a vane to be moved forward or rearward in a radial direction of the compressing chamber,
wherein the vane is moved forward or rearward depending on an opening rate of the expansion valve.

2. The compressor according to claim 1, wherein a pulling member is placed between an inner circumferential surface of the housing and a rear end of the vane and serves to force the vane rearward.

3. The compressor according to claim 2, wherein the pulling member is a magnet.

4. The compressor according to claim 2, wherein the pulling member is an elastic member.

5. The compressor according to claim 1, further comprising a bypass valve placed in parallel to the expansion valve to bypass refrigerant to be introduced into the expansion valve.

6. The compressor according to claim 1, wherein the vane is divided into at least two individually movable vanes.

7. The compressor according to claim 6, wherein the pulling member is placed at the rear of one of the at least two divided vanes.

8. A compressor used in an air conditioning system including a condenser, a compressor, an evaporator, and an expansion valve, the compressor comprising:
a housing;
a first compressing chamber and a second compressing chamber defined in the housing;
a first vane to be moved forward or rearward in a radial direction of the first compressing chamber; and
a second vane to be moved forward or rearward in a radial direction of the second compressing chamber,
wherein any one of the first vane and the second vane is moved forward or rearward depending on an opening rate of the expansion valve.

9. The compressor according to claim 8, wherein the first compressing chamber is located above the second compressing chamber.

10. The compressor according to claim 8, wherein a pulling member is placed at the rear of any one of the first vane and the second vane and serves to force any one of the first vane and the second vane rearward.

11. The compressor according to claim 10, wherein the pulling member is a magnet.

12. The compressor according to claim 10, wherein the pulling member is an elastic member.

13. The compressor according to claim 8, further comprising a bypass valve placed in parallel to the expansion valve to bypass refrigerant to be introduced into the expansion valve.

14. The compressor according to claim 8, wherein any one of the first vane and the second vane is divided into at least two individually movable vanes.

15. A compressor used in an air conditioning system including a condenser, a compressor, an evaporator, and an expansion valve, the compressor comprising:
a housing;
a low-pressure pipe connected to the housing to enable introduction of relatively low-pressure refrigerant;
a high-pressure pipe connected to the housing to enable discharge of relatively high-pressure refrigerant;
a first compressing chamber and a second compressing chamber defined in the housing; and
a first vane to be moved forward or rearward in a radial direction of the first compressing chamber and a second vane to be moved forward or rearward in a radial direction of the second compressing chamber,
wherein any one of the first vane and the second vane is moved forward or rearward depending on a difference between the pressure of refrigerant introduced into the low-pressure pipe and the pressure of refrigerant discharged from the high-pressure pipe.

16. The compressor according to claim 15, wherein the difference between the pressure of refrigerant introduced into the low-pressure pipe and the pressure of refrigerant discharged from the high-pressure pipe is adjusted by controlling an opening rate of the expansion valve.

17. The compressor according to claim 16, further comprising a bypass valve placed in parallel to the expansion valve to bypass refrigerant to be introduced into the expansion valve.

18. The compressor according to claim 17, wherein a pulling member is placed at the rear of any one of the first vane and the second vane and serves to force any one of the first vane and the second vane rearward.

19. The compressor according to claim 16, wherein any one of the first vane and the second vane is divided into at least two individually movable vanes.

20. A compressor used in an air conditioning system including a condenser, a compressor, an evaporator and an expansion valve, the compressor comprising:
a housing;
a low-pressure pipe connected to the housing to enable introduction of relatively low-pressure refrigerant;
a high-pressure pipe connected to the housing to enable discharge of relatively high-pressure refrigerant;
a first compressing chamber and a second compressing chamber defined in the housing; and
a first vane to be moved forward or rearward in a radial direction of the first compressing chamber and a second vane to be moved forward or rearward in a radial direction of the second compressing chamber,
wherein any one of the first vane and the second vane is moved forward or rearward as a difference between the pressure of refrigerant introduced into the low-pressure pipe and the pressure of refrigerant discharged from the high-pressure pipe is adjusted by controlling an opening rate of the expansion valve.

21. The compressor according to claim 1, wherein the vane is divided into an upper vane and a lower vane, and a pulling member is placed between an inner circumferential surface of the housing and at a rear end of the upper vane and serves to force the upper vane rearward, and
wherein the upper vane is separated from the lower vane to be moved forward or rearward independently of the lower vane.

22. The compressor according to claim 8, wherein the first vane is divided into an upper first vane and a lower first vane, and a pulling member is placed at the rear of the upper first vane so that the upper first vane is separated from the lower first vane to be moved forward or rearward independently of the lower first vane.

23. The compressor according to claim 15, wherein the first vane is divided into an upper first vane and a lower first vane, and a pulling member is placed at the rear of the upper first vane so that the upper first vane is separated from the lower first vane to be moved forward or rearward independently of the lower first vane.

24. The compressor according to claim 8, wherein at least one of the first vane or the second vane is divided into an upper vane and a lower vane, and a pulling member is placed at the rear of the upper vane so that the upper vane is separated from the lower vane to be moved forward or rearward independently of the lower vane.
